(19) United States
(12) Patent Application Publication
(10) Pub. No.: US 2020/0142169 A1
(43) Pub. Date: May 7, 2020

(54) SYNCHRONOUS ORTHOGONAL LASER IMAGE RECONSTRUCTION SUPER-RESOLUTION MICROSCOPE

(71) Applicant: Shiping GU, SUZHOU (CN)

(72) Inventors: Shiping GU, SUZHOU (CN); Haitao GU, SUZHOU (CN)

(73) Assignee: Shiping GU

(21) Appl. No.: 16/730,990

(22) Filed: Dec. 30, 2019

Related U.S. Application Data
(63) Continuation of application No. PCT/CN2018/075008, filed on Feb. 2, 2018.

(30) Foreign Application Priority Data
Jan. 30, 2018 (CN) 201810090201.3

(51) Int. Cl. G02B 21/00; G02B 21/36; G02B 21/02

(52) U.S. Cl. CPC G02B 21/0068; G02B 21/0072; G02B 21/025; G02B 21/0092; G02B 21/365; G02B 21/008

(57) ABSTRACT

The present invention relates to the synchronous orthogonal laser image reconstruction super-resolution microscope: the synchronous orthogonal laser image reconstruction super-resolution microscope comprises reconstruction of synchronous multiple polarized light images; spherical aberration correction; acquisition of dynamic rotary polarized light images; imaging processing of the orthogonal polarized image, and reconstruction of the microscopic image; image reconstruction of the polarized light image group at any angle; and generation of rotary polarized light. The influence of optical diffraction spots on the resolution of the optical microscope is overcome; the Abbe limit is broken through; and the existing opinion that the optical diffraction limit cannot be broken through is overturned. Another way is provided for relevant researches, and the resolution of the optical microscope is greatly improved.

### CROSS-REFERENCE TO RELATED APPLICATIONS

This application is a continuation of International Patent Application No. PCT/CN2018/075008 with a filing date of Feb. 2, 2018, designating the United States, now pending, and further claims priority to Chinese Patent Application No. 201810090201.3 with a filing date of Jan. 30, 2018. The content of the aforementioned applications, including any intervening amendments thereto, are incorporated herein by reference.

### TECHNICAL FIELD

The present invention relates to a synchronous orthogonal laser image reconstruction super-resolution microscope, and particularly relates to a rotary polarized laser image reconstruction microscope using a rotary polarized light apparatus.

### BACKGROUND OF THE PRESENT INVENTION

Existing optical microscopes: due to the diffraction limit of light, a minimum display resolution size of the optical microscope is 0.2 micrometer, and due to the extremely low resolution, the optical microscope is inapplicable to a sample of a nanometer size and is more incapable of the imaging of atomic-scale samples; and although the resolution of a fluorescence microscope has been improved, the resolution has not been improved greatly, and fluorescence samples are needed for imaging, so the application range is limited.

Transmission electron microscopes: a resolution size of a transmission electron microscope with a spherical aberration corrector is 0.74 angstrom; the further increase of the resolution size requires the increase of acceleration voltage, which is easy to damage a sample; in addition, under the influence of the uncertainty principle, the resolution size is almost a display limit of the transmission electron microscope; moreover, the transmission electron microscope needs high voltage and complicated equipment, and is high in cost and large in electron energy, which influences measurement parameters of the sample; and high-energy electrons may damage the sample, and a large number of samples, such as biological live samples cannot be measured on site. Furthermore, scanning electron microscopes, atom tunnel microscopes and atomic force microscopes are limited in potential of improving the resolution.

### SUMMARY OF PRESENT INVENTION

Problems to be solved: the present invention aims at solving the problem that the existing optical microscope is low in image resolution due to the diffraction.

### Technical Solutions

reconstruction of a synchronous orthogonal laser image: synchronous horizontal polarized laser rays and vertical polarized laser rays are alternately used to pass through a sample; when the synchronous horizontal polarized laser rays are magnified by a multilevel lens group to form a magnified real image, the formed image is subjected to spherical aberration correction by a spherical aberration correction component, and a magnified real image 1 is formed on an optical screen, a CCD, a CMOS or a crystal sensitive plate; then the synchronous vertical polarized laser rays pass through the sample and are magnified by the multilevel lens group, the formed image is subjected to the spherical aberration correction by the spherical aberration correction component, and a magnified real image 2 is formed on the optical screen, CCD, CMOS or crystal sensitive plate; the magnified real image 1 and the magnified real image 2 are subjected to the image correlation processing; the greater the correlation is, the greater the grayscale of the image point is; the weaker the correlation is, the smaller the grayscale of the image is; then the real image is filtered and reconstructed into a new super-resolution microscopic image; the horizontal polarized laser rays and the vertical polarized laser rays alternately and circularly pass through the sample, and a dynamic super-resolution image of the sample can be obtained by virtue of the image reconstruction;

reconstruction of synchronous multiple polarized light images: the synchronous polarized laser rays form a transmitted image whenever rotating by an angle (the rotating angle can be set, and a 360/rotating angular-amplitude image can be formed when the polarized light rotates in one circle); the images formed when the polarized light rotates in one circle form a group of (360/rotating angle) polarized light images; one group of polarized light images is subjected to image correlation processing through a computer to form a grayscale image according to the correlation strength; then the grayscale image is filtered and reconstructed into a super-resolution microscopic image; and the polarized light rotates circularly and is processed, thereby obtaining a super-resolution image of a dynamic sample;

spherical aberration correction: the imaging spherical aberration is corrected by the spherical aberration correction component arranged behind the multilevel lenses, so that a clearer image can be formed; or each level of lens magnified images is subjected to the spherical aberration correction by the spherical aberration correction component arranged between the magnification lens group, thereby forming a higher-super-resolution microscopic image;

acquisition of a dynamic rotation polarized light image: a synchronous orthogonal image reconstruction super-resolution microscope light source is generated by a same laser, and a polarized light filter is used for filtering the laser rays to form the polarized light; or the laser light source is filtered by the polarized light filter to form the polarized light; then the polarized light passes through an optical rotation component; the polarized laser is deflected to form rotary polarized laser rays at different time; the rotating polarized laser rays pass through the sample at different time to form the image; the formed image is reconstructed by the computer into a new super-resolution image; or the synchronous orthogonal laser image reconstruction super-resolution microscope light source is generated by the laser, the polarized light filter is used for filtering the polarized light, thereby obtaining the orthogonal polarized laser rays at different time; and the image formed by the polarized laser rays passing through the sample at different time is reconstructed by the computer into the new super-resolution image;

imaging processing of the orthogonal polarized image: the imaging is carried out in a film exposure imaging manner, or the imaging is displayed by the optical screen; or during the imaging, image information is acquired by a CCD image coupling device and transmitted to the computer for processing, storage and display; or an imaging CMOS image sensor acquires the image information and transmits the image information to the computer for processing, storage and display; or the image is induced to emit light through the crystal sensitive plate and then magnified by the optical lenses, thereby forming an image with higher resolution;

image reconstruction of a polarized light image group at any angle: a polarizing plate 2 (105) may adopt a rotary polarizing plate or an electric control liquid crystal polarizing module or an electric control crystal polarizing module or an electric control optical rotation module;

the polarizing plate 2 (105) and the polarizing plate 1 or the polarizing plate 1 in the optical rotation module (102) are controlled to be consistent in polarization direction;

system composition: a laser light source (101), a polarizing plate 1 or an optical rotation component (102), a multilevel lens group (103), a spherical aberration correction component (104), a polarizing plate 2 (105), an optical screen or CCD or CMOS or crystal sensitive plate (106), and a computer (107); the laser light source (101) generates synchronous laser sources;

or the laser light source (101) is provided with two perpendicular light emitting surfaces and a resonant cavity, one group of light-emitting surfaces generates horizontal polarized laser rays; the other group of light emitting surfaces generates vertical polarized laser rays; the two light emitting surfaces are controlled at different time, so that the horizontal polarized laser rays and the vertical polarized laser rays are emitted at different time;

generation of rotary polarized light: a rotary polarizing wafer is used to generate synchronous rotary polarized light, or an electric control liquid crystal polarizing module is used to generate synchronous rotary polarized light, or an electric control crystal polarizing module is used to generate synchronous rotary polarized light, or an electric control optical rotation module is used to generate synchronous rotary polarized light.

System composition: a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107); the laser light source (101) generates synchronous laser sources;

the laser light source (101) adopts a semiconductor laser, or a gas laser or a solid laser;

or the laser light source (101) is provided with two perpendicular light emitting surfaces and a resonant cavity; one group of light-emitting surfaces generates horizontal polarized laser rays; the other group of light emitting surfaces generates vertical polarized laser rays; the two light emitting surfaces are controlled at different time, so that the horizontal polarized light and the vertical polarized light are transmitted at different time;

the polarizing plate 1 or the optical rotation component (102) adopts a rotary polarizing wafer, or an electric control liquid crystal polarizing module, or an electric control crystal polarizing module or an electric control optical rotation module;

the multilevel optical lens group (103) adopts a lens group to magnify an object image;

the spherical aberration correction component (104) is used to perform the spherical aberration correction for the object image magnified by the lens group; (because the light sources are laser rays, the wavelength and the phase are same, and the color difference correction is not required);

spherical aberration correction: the imaging spherical aberration is corrected by the spherical aberration correction component arranged behind the multilevel lenses, thereby forming a clearer image; or each level of magnified image is subjected to the spherical aberration correction by the spherical aberration correction component arranged between the magnification lens group, thereby forming a higher-super-resolution microscopic image;

the polarizing plate 2 (105) is used to filter the image passing through the multilevel optical lens group (103) and the spherical aberration correction component (104) to remove other reflected light, so that the image is clearer, the polarizing plate 2 (105) adopts a rotary polarizing wafer, or an electric control liquid crystal polarizing module, or an electric control crystal polarizing module or an electric control optical rotation module; or the polarizing plate 2 (105) may not be used;

for the optical screen or CCD or CMOS or liquid crystal sensitive plate (106), the optical screen may be adopted for direct imaging; or the image information obtained by the CCD image coupling device is processed, stored and displayed by the computer, or the image information obtained by the CMOS image sensor is processed, stored and displayed by the computer, or the crystal sensitive plate emits the light by induction, and the light is magnified by the optical part for imaging;

the image obtained by the CCD image coupling device or the CMOS image sensor is transmitted to the computer (107) for processing, imaging, storage and printing.

Generation of rotary polarized light: the rotary polarizing wafer is used to generate synchronous rotary polarized light, or the electric control liquid crystal polarizing module is used to generate the synchronous rotary polarized light, or the electric control crystal polarizing module is used to generate the synchronous rotary polarized light, or the electric control optical rotation module is used to generate the synchronous rotary polarized light;

the polarizing plate 1 or the polarizing plate 1 in the optical rotary part (102): the polarizing plate 1 adopts a polarizing disc which is a polarizing wafer, the center of the polarizing wafer is fixed by a rotating shaft of a motor; the motor drives the polarizing wafer to rotate; a laser light source (202) is fixed on the polarizing wafer outside the center of the polarizing disc; the laser rays are perpendicularly incident on the polarizing wafer, formation of polarized laser rays: a motor (201), a motor rotating shaft (204), a polarizing wafer (203), a laser source (202), a laser ray (205), a laser ray (206), a mark point (207), a luminescent tube (208) and a photoelectric detector (209); the motor rotating shaft (204) drives the polarizing wafer (203) to rotate; polarized laser ray positioning signals: light rays of the luminescent tube (208) and the mark point (207), and the photoelectric detector (209) detects a rotation position status of the polarizing wafer (203) (prior art); the laser ray (205) emitted by the laser source (202) passes through the polarizing wafer (203) and is filtered by the polarizing wafer (203) to form the polarized laser ray (206);

when the horizontal and vertical laser rays (205) at two moments pass through a sample film, and pass through the multilevel optical lens group (103), the spherical aberration correction component (104), the optical screen or the CCD or the CMOS or the crystal sensitive plate (106) to form a magnified real image, the horizontal polarized magnified real image 1 and the vertical polarized magnified real image 2 at two moments are processed by the computer, or the magnified real image 1 and the magnified real image 2 are subjected to the image correlation processing, image reconstruction and image filtering to form a new super-resolution microscopic image.

the polarizing plate 1 or the polarizing plate 1 in the optical rotation component (102): the polarizing plate 1 adopts an electric control liquid crystal polarizing module (302), and a polarization direction of the laser rays passing through the electric control liquid crystal polarizing module is controlled by a level at a control end;

the polarizing plate 1 or the polarizing plate 1 in the optical rotation component (102): the polarizing plate 1 adopts an electric control crystal polarizing module (402), and the polarization direction of the laser rays passing through the electric control crystal polarizing module is controlled by the level at the control end;

the polarizing plate 1 or an electric control optical rotation component in the optical rotation component (102): the electric control optical rotation component controls the laser light source (501) as that of the optical rotation module (502), and the polarization direction of the laser rays passing through the electric control optical rotation polarizing module is controlled by the level at the control end;

the polarizing plate 2 (105) may adopt a motor rotation polarizing plate coaxial with the polarizing plate 1, or an electric control liquid crystal polarizing module or an electric control crystal polarizing module or an electric control optical rotation module; and the polarization direction of the polarizing plate 2 (105) is controlled to be consistent with that of the polarizing plate 1 or the polarizing plate 1 in the optical rotation module (102).

The light source is generated by a same laser, and filtered by the polarizing filter to form polarized light; or the laser light source is filtered by the polarizing filter to form polarized light, and then the polarized light passes through the electric control optical rotation module (502) to form orthogonal laser rays at different time; two images formed by the laser rays passing through the sample at different time are reconstructed by the computer into the new super-resolution image;

or the light source adopts the laser to generate laser rays; the laser rays are rotated by the polarizing wafer (203) to form the orthogonal polarized laser rays at different time; and the two images formed by the orthogonal polarized laser rays passing through the sample at different time are reconstructed by the computer into the new super-resolution image;

imaging processing of the orthogonal polarized image: the imaging is carried out in a film exposure imaging manner, or the imaging is displayed by the optical screen; or the image information is acquired by the CCD image coupling device and transmitted to the computer for processing, storage and display; or the image information is acquired by the imaging CMOS image sensor and transmitted to the computer for processing, storage and display; or the image is induced to emit light by the crystal sensitive plate, and then magnified by the optical lenses, thereby forming the image with higher resolution;

the laser rays are transverse waves; the laser rays are coherent light rays having same phase and wavelength; when the two orthogonal beams of polarized laser rays pass through a point on the sample, the polarized laser rays pass through the multilevel optical lens group (103) and the spherical aberration correction component (104) to form the magnified real image; the magnified real image is formed on the optical screen or CCD or CMOS or crystal sensitive plate (106), and the orthogonal waves are strengthened on a same phase point and are counteracted on other points; according to the present invention, photon fluctuation sites of laser light waves rather than the wave properties are actually used for imaging, thereby forming the clear image, overcoming the restriction of Abbe optics limit, and forming the super-resolution image.

Imaging processing of the synchronous polarized image: the synchronous polarized laser rays form a transmitted image whenever rotating by an angle (which may be set arbitrarily), and the images formed by the polarized light rotating in one circle is reconstructed by the computer into the super-resolution microscopic image;

system composition: a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107);

or the laser rays emitted by the laser light source (101) pass through the polarizing plate 1 or the optical rotation component (102) to form polarized light which is transmitted onto the sample; the transmitted laser rays pass through the multilevel optical lens group (103) to form the magnified image; the magnified image is corrected by the spherical aberration correction component (104); a polarizing surface of the polarizing plate 2 (105) is same as the polarizing plate 1 or the optical rotation component (102); other light rays are removed by filtering through the polarizing plate 2 (105); the synchronous light forms a polarized light image on the optical screen or CCD or CMOS or crystal sensitive plate (106); and the polarized light image 1 acquired by the CCD or CMOS image sensor in the polarized light image optical screen or CCD or CMOS or crystal sensitive plate (106) is transmitted to the computer (107) for processing, storage and display;

the polarizing plate 1 or the optical rotation component (102) rotates by a settable angle, so that the polarized light of the light rays rotates by an angle, and a polarized light image 2 is formed on the optical screen or CCD or CMOS or crystal sensitive plate (106) and transmitted to the computer (107);

the polarizing plate 1 or the optical rotation component (102) rotates by a settable angle, so that the polarized light of the light rays rotates by an angle, and a polarized light image 3 is formed on the optical screen or CCD or crystal sensitive plate (106) and transmitted to the computer (107);

the polarizing plate 1 or the optical rotation component (102) rotates by n settable angles, so that the polarized light of the light rays rotates by an angle; a polarized light image n is formed on the optical screen or CCD or CID or crystal sensitive plate (106) and transmitted to the computer (107);

the polarizing plate 1 or the optical rotation component (102) rotates by 360 degrees, and n polarized light images are formed and are reconstructed by the computer (107) into a super-high-resolution microscopic image;

the polarized light rays of the polarizing plate 1 or the optical rotation component (102) and the polarized light rays of the polarizing plate 2 (105) are in a synchronous state; or the polarizing plate 2 (105) may not be used, i.e. the polarizing plate 2 (105) is omitted.

Beneficial effects: the present invention relates to the synchronous orthogonal laser image reconstruction super-resolution microscope: the synchronous orthogonal laser image reconstruction super-resolution microscope comprises reconstruction of synchronous multiple polarized light images; spherical aberration correction; acquisition of dynamic rotary polarized light images; imaging processing of the orthogonal polarized image, and reconstruction of the microscopic image; image reconstruction of the polarized light image group at any angle; and generation of rotary polarized light. The influence of optical diffraction spots on the resolution of the optical microscope is overcome; the Abbe limit is broken through; and the existing opinion that the optical diffraction limit cannot be broken through is overturned. Another way is provided for relevant researches, and the resolution of the optical microscope is greatly improved. A new observation means is provided for the biological on-site microscopic image observation, microscopic imaging of a chemical reaction bonding process, microscopic imaging of nano materials, etc. A resolution limit of the present microscope is a photon diameter, the photon diameter is not known at present but is ensured to be less than 10⁻¹⁵ meters. Since the photon has no rest mass, the influence of the uncertainty principle on the imaging accuracy of the photon microscope is much smaller, and the accuracy may be higher. The image resolution is increased by several orders of magnitudes compared with the existing electron microscope.

### DESCRIPTION OF THE DRAWINGS

FIG. 1 is a composition block diagram of a synchronous orthogonal laser image reconstruction super-resolution microscope;

FIG. 2 is a block diagram of a forming principle of polarized laser rays;

FIG. 3 is a control block diagram of electric control liquid crystal polarized light;

FIG. 4 is a control block diagram of electric control crystal polarized light; and

FIG. 5 is a control block diagram of electric control optical rotation polarized light.

### DETAILED DESCRIPTION OF PREFERRED EMBODIMENTS

The implementation modes of the present invention are described in detail below in combination with the drawings:

### Preferred Embodiment 1

reconstruction of a synchronous orthogonal laser image: synchronous horizontal polarized laser rays and vertical polarized laser rays are alternately used to pass through a sample; when the synchronous horizontal polarized laser rays are magnified by a multilevel lens group to form a magnified real image, the formed image is subjected to spherical aberration correction by a spherical aberration correction component, and a magnified real image 1 is formed on an optical screen, a CCD, a CMOS or a crystal sensitive plate; then the synchronous vertical polarized laser rays pass through the sample and are magnified by the multilevel lens group, the formed image is subjected to the spherical aberration correction by the spherical aberration correction component, and a magnified real image 2 is formed on the optical screen. CCD, CMOS or crystal sensitive plate; the magnified real image 1 and the magnified real image 2 are subjected to the image correlation processing; the greater the correlation is, the greater the grayscale of the image point is; the weaker the correlation is, the smaller the grayscale of the image is; then the real image is filtered and reconstructed into a new super-resolution microscopic image; the horizontal polarized laser rays and the vertical polarized laser rays alternately and circularly pass through the sample, and a dynamic super-resolution image of the sample can be obtained by virtue of the image reconstruction;

reconstruction of synchronous multiple polarized light images: the synchronous polarized laser rays form a transmitted image whenever rotating by an angle (the rotating angle can be set, and a 360/rotating angular-amplitude image can be formed when the polarized light rotates in one circle); the images formed when the polarized light rotates in one circle form a group of (360/rotating angle) polarized light images; one group of polarized light images is subjected to image correlation processing through a computer to form a grayscale image according to the correlation strength; then the grayscale image is filtered and reconstructed into a super-resolution microscopic image; and the polarized light rotates circularly and is processed, thereby obtaining a super-resolution image of a dynamic sample;

spherical aberration correction: the imaging spherical aberration is corrected by the spherical aberration correction component arranged behind the multilevel lenses, so that a clearer image can be formed; or each level of lens magnified images is subjected to the spherical aberration correction by the spherical aberration correction component arranged between the magnification lens group, thereby forming a higher-super-resolution microscopic image;

acquisition of a dynamic rotation polarized light image: a synchronous orthogonal image reconstruction super-resolution microscope light source is generated by a same laser, and a polarized light filter is used for filtering the laser rays to form the polarized light; or the laser light source is filtered by the polarized light filter to form the polarized light; then the polarized light passes through an optical rotation component; the polarized laser is deflected to form rotary polarized laser rays at different time; the rotating polarized laser rays pass through the sample at different time to form the image; the formed image is reconstructed by the computer into a new super-resolution image; or the synchronous orthogonal laser image reconstruction super-resolution microscope light source is generated by the laser, the polarized light filter is used for filtering the polarized light, thereby obtaining the orthogonal polarized laser rays at different time; and the image formed by the polarized laser rays passing through the sample at different time is reconstructed by the computer into the new super-resolution image;

imaging processing of the orthogonal polarized image: the imaging is carried out in a film exposure imaging manner, or the imaging is displayed by the optical screen; or during the imaging, image information is acquired by a CCD image coupling device and transmitted to the computer for processing, storage and display, or an imaging CMOS image sensor acquires the image information and transmits the image information to the computer for processing, storage and display, or the image is induced to emit light through the crystal sensitive plate and then magnified by the optical lenses, thereby forming an image with higher resolution;

image reconstruction of a polarized light image group at any angle: a polarizing plate 2 (105) may adopt a rotary polarizing plate or an electric control liquid crystal polarizing module or an electric control crystal polarizing module or an electric control optical rotation module;

the polarizing plate 2 (105) and the polarizing plate 1 or the polarizing plate 1 in the optical rotation module (102) are controlled to be consistent in polarization direction;

system composition: a laser light source (101), a polarizing plate 1 or an optical rotation component (102), a multilevel lens group (103), a spherical aberration correction component (104), a polarizing plate 2 (105), an optical screen or CCD or CMOS or crystal sensitive plate (106), and a computer (107); the laser light source (101) generates synchronous laser sources;

or the laser light source (101) is provided with two perpendicular light emitting surfaces and a resonant cavity, one group of light-emitting surfaces generates horizontal polarized laser rays; the other group of light emitting surfaces generates vertical polarized laser rays; the two light emitting surfaces are controlled at different time, so that the horizontal polarized laser rays and the vertical polarized laser rays are emitted at different time;

generation of rotary polarized light: a rotary polarizing wafer is used to generate synchronous rotary polarized light, or an electric control liquid crystal polarizing module is used to generate synchronous rotary polarized light, or an electric control crystal polarizing module is used to generate synchronous rotary polarized light, or an electric control optical rotation module is used to generate synchronous rotary polarized light.

### Preferred Embodiment 2

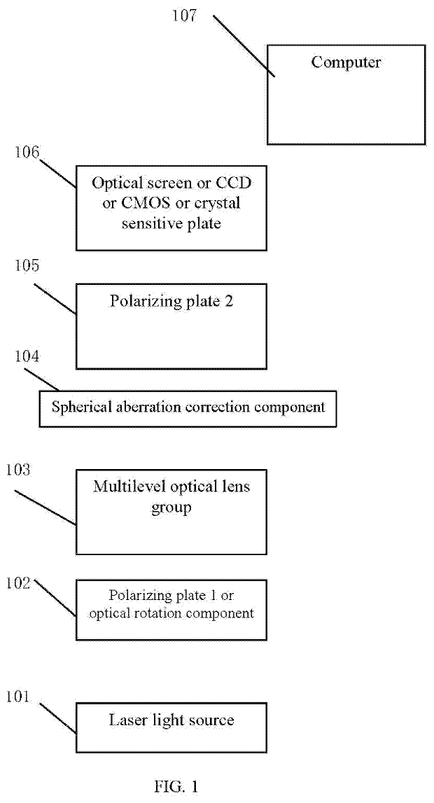

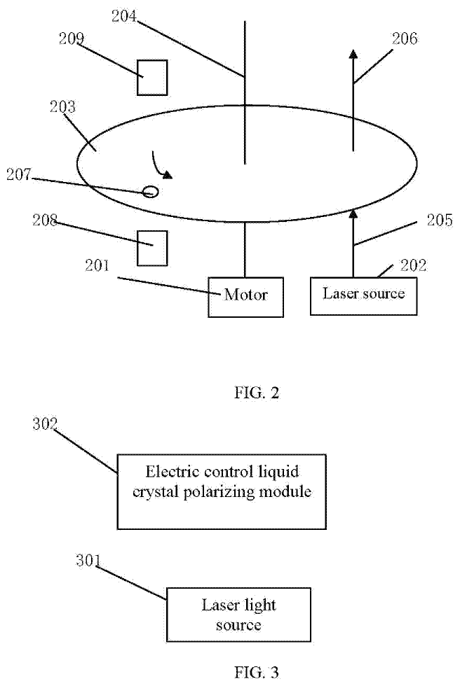

As shown in FIG. 1, system composition: a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107); the laser light source (101) generates synchronous laser sources;

the laser light source (101) adopts a semiconductor laser, or a gas laser or a solid laser;

or the laser light source (101) is provided with two perpendicular light emitting surfaces and a resonant cavity; one group of light-emitting surfaces generates horizontal polarized laser rays; the other group of light emitting surfaces generates vertical polarized laser rays; the two light emitting surfaces are controlled at different time, so that the horizontal polarized light and the vertical polarized light are transmitted at different time;

the polarizing plate 1 or the optical rotation component (102) adopts a rotary polarizing wafer, or an electric control liquid crystal polarizing module, or an electric control crystal polarizing module or an electric control optical rotation module;

the multilevel optical lens group (103) adopts a lens group to magnify an object image;

the spherical aberration correction component (104) is used to perform the spherical aberration correction for the object image magnified by the lens group; (because the light sources are laser rays, the wavelength and the phase are same, and the color difference correction is not required);

spherical aberration correction: the imaging spherical aberration is corrected by the spherical aberration correction component arranged behind the multilevel lenses, thereby forming a clearer image; or each level of magnified image is subjected to the spherical aberration correction by the spherical aberration correction component arranged between the magnification lens group, thereby forming a higher-super-resolution microscopic image;

the polarizing plate 2 (105) is used to filter the image passing through the multilevel optical lens group (103) and the spherical aberration correction component (104) to remove other reflected light, so that the image is clearer, the polarizing plate 2 (105) adopts a rotary polarizing wafer, or an electric control liquid crystal polarizing module, or an electric control crystal polarizing module or an electric control optical rotation module; or the polarizing plate 2 (105) may not be used;

for the optical screen or CCD or CMOS or liquid crystal sensitive plate (106), the optical screen may be adopted for direct imaging; or the image information obtained by the CCD image coupling device is processed, stored and displayed by the computer, or the image information obtained by the CMOS image sensor is processed, stored and displayed by the computer, or the crystal sensitive plate emits the light by induction, and the light is magnified by the optical part for imaging;

the image obtained by the CCD image coupling device or the CMOS image sensor is transmitted to the computer (107) for processing, imaging, storage and printing.

### Preferred Embodiment 3

Generation of rotary polarized light: the rotary polarizing wafer is used to generate synchronous rotary polarized light, or the electric control liquid crystal polarizing module is used to generate the synchronous rotary polarized light, or the electric control crystal polarizing module is used to generate the synchronous rotary polarized light, or the electric control optical rotation module is used to generate the synchronous rotary polarized light;

the polarizing plate 1 or the polarizing plate 1 in the optical rotary part (102): the polarizing plate 1 adopts a polarizing disc which is a polarizing wafer, the center of the polarizing wafer is fixed by a rotating shaft of a motor, the motor drives the polarizing wafer to rotate; a laser light source (202) is fixed on the polarizing wafer outside the center of the polarizing disc; the laser rays are perpendicularly incident on the polarizing wafer, formation of polarized laser rays: a motor (201), a motor rotating shaft (204), a polarizing wafer (203), a laser source (202), a laser ray (205), a laser ray (206), a mark point (207), a luminescent tube (208) and a photoelectric detector (209); the motor rotating shaft (204) drives the polarizing wafer (203) to rotate; polarized laser ray positioning signals: light rays of the luminescent tube (208) and the mark point (207), and the photoelectric detector (209) detects a rotation position status of the polarizing wafer (203) (prior art); the laser ray (205) emitted by the laser source (202) passes through the polarizing wafer (203) and is filtered by the polarizing wafer (203) to form the polarized laser ray (206);

when the horizontal and vertical laser rays (205) at two moments pass through a sample film, and pass through the multilevel optical lens group (103), the spherical aberration correction component (104), the optical screen or the CCD or the CMOS or the crystal sensitive plate (106) to form a magnified real image, the horizontal polarized magnified real image 1 and the vertical polarized magnified real image 2 at two moments are processed by the computer, or the magnified real image 1 and the magnified real image 2 are subjected to the image correlation processing, image reconstruction and image filtering to form a new super-resolution microscopic image.

### Preferred Embodiment 4

As shown in FIG. 3, the polarizing plate 1 or the polarizing plate 1 in the optical rotation component (102): the polarizing plate 1 adopts an electric control liquid crystal polarizing module (302), and a polarization direction of the laser rays passing through the electric control liquid crystal polarizing module is controlled by a level at a control end;

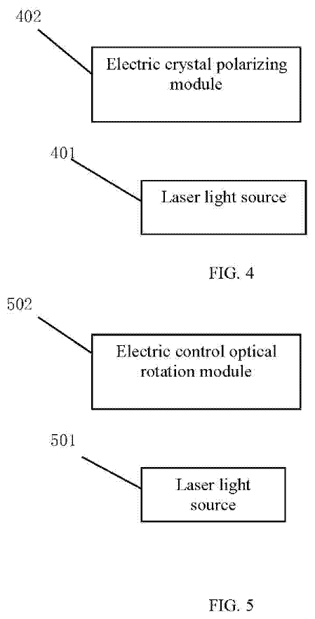

or as shown in FIG. 4, the polarizing plate 1 or the polarizing plate 1 in the optical rotation component (102): the polarizing plate 1 adopts an electric control crystal polarizing module (402), and the polarization direction of the laser rays passing through the electric control crystal polarizing module is controlled by the level at the control end;

or as shown in FIG. 5, the polarizing plate 1 or an electric control optical rotation component in the optical rotation component (102): the electric control optical rotation component controls the laser light source (501) as that of the optical rotation module (502), and the polarization direction of the laser rays passing through the electric control optical rotation polarizing module is controlled by the level at the control end;

the polarizing plate 2 (105) may adopt a motor rotation polarizing plate coaxial with the polarizing plate 1, or an electric control liquid crystal polarizing module or an electric control crystal polarizing module or an electric control optical rotation module; and the polarization direction of the polarizing plate 2 (105) is controlled to be consistent with that of the polarizing plate 1 or the polarizing plate 1 in the optical rotation module (102).

### Preferred Embodiment 5

The light source is generated by a same laser, and filtered by the polarizing filter to form polarized light; or the laser light source is filtered by the polarizing filter to form polarized light, and then the polarized light passes through the electric control optical rotation module (502) to form orthogonal laser rays at different time; two images formed by the laser rays passing through the sample at different time are reconstructed by the computer into the new super-resolution image;

or the light source adopts the laser to generate laser rays; the laser rays are rotated by the polarizing wafer (203) to form the orthogonal polarized laser rays at different time; and the two images formed by the orthogonal polarized laser rays passing through the sample at different time are reconstructed by the computer into the new super-resolution image;

imaging processing of the orthogonal polarized image: the imaging is carried out in a film exposure imaging manner, or the imaging is displayed by the optical screen; or the image information is acquired by the CCD image coupling device and transmitted to the computer for processing, storage and display; or the image information is acquired by the imaging CMOS image sensor and transmitted to the computer for processing, storage and display, or the image is induced to emit light by the crystal sensitive plate, and then magnified by the optical lenses, thereby forming the image with higher resolution;

the laser rays are transverse waves; the laser rays are coherent light rays having same phase and wavelength; when the two orthogonal beams of polarized laser rays pass through a point on the sample, the polarized laser rays pass through the multilevel optical lens group (103) and the spherical aberration correction component (104) to form the magnified real image; the magnified real image is formed on the optical screen or CCD or CMOS or crystal sensitive plate (106), and the orthogonal waves are strengthened on a same phase point and are counteracted on other points; according to the present invention, photon fluctuation sites of laser light waves rather than the wave properties are actually used for imaging, thereby forming the clear image, overcoming the restriction of Abbe optics limit, and forming the super-resolution image.

### Preferred Embodiment 6

Imaging processing of the synchronous polarized image: the synchronous polarized laser rays form a transmitted image whenever rotating by an angle (which may be set arbitrarily), and the images formed by the polarized light rotating in one circle is reconstructed by the computer into the super-resolution microscopic image;

system composition: a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107);

or the laser rays emitted by the laser light source (101) pass through the polarizing plate 1 or the optical rotation component (102) to form polarized light which is transmitted onto the sample; the transmitted laser rays pass through the multilevel optical lens group (103) to form the magnified image; the magnified image is corrected by the spherical aberration correction component (104); a polarizing surface of the polarizing plate 2 (105) is same as the polarizing plate 1 or the optical rotation component (102); other light rays are removed by filtering through the polarizing plate 2 (105); the synchronous light forms a polarized light image on the optical screen or CCD or CMOS or crystal sensitive plate (106); and the polarized light image 1 acquired by the CCD or CMOS image sensor in the polarized light image optical screen or CCD or CMOS or crystal sensitive plate (106) is transmitted to the computer (107) for processing, storage and display;

the polarizing plate 1 or the optical rotation component (102) rotates by a settable angle, so that the polarized light of the light rays rotates by an angle, and a polarized light image 2 is formed on the optical screen or CCD or CMOS or crystal sensitive plate (106) and transmitted to the computer (107);

the polarizing plate 1 or the optical rotation component (102) rotates by a settable angle, so that the polarized light of the light rays rotates by an angle, and a polarized light image 3 is formed on the optical screen or CCD or crystal sensitive plate (106) and transmitted to the computer (107);

the polarizing plate 1 or the optical rotation component (102) rotates by n settable angles, so that the polarized light of the light rays rotates by an angle; a polarized light image n is formed on the optical screen or CCD or CID or crystal sensitive plate (106) and transmitted to the computer (107);

the polarizing plate 1 or the optical rotation component (102) rotates by 360 degrees, and n polarized light images are formed and are reconstructed by the computer (107) into a super-high-resolution microscopic image;

the polarized light rays of the polarizing plate 1 or the optical rotation component (102) and the polarized light rays of the polarizing plate 2 (105) are in a synchronous state; or the polarizing plate 2 (105) may not be used, i.e. the polarizing plate 2 (105) is omitted.

The present invention relates to the synchronous orthogonal laser image reconstruction super-resolution microscope: the synchronous orthogonal laser image reconstruction super-resolution microscope comprises reconstruction of synchronous multiple polarized light images; spherical aberration correction; acquisition of dynamic rotary polarized light images; imaging processing of the orthogonal polarized image, and reconstruction of the microscopic image; image reconstruction of the polarized light image group at any angle; and generation of rotary polarized light. The influence of optical diffraction spots on the resolution of the optical microscope is overcome; the Abbe limit is broken through; and the existing opinion that the optical diffraction limit cannot be broken through is overturned. Another way is provided for relevant researches, and the resolution of the optical microscope is greatly improved. A new observation means is provided for the biological on-site microscopic image observation, microscopic imaging of a chemical reaction bonding process, microscopic imaging of nano materials, etc. A resolution limit of the present microscope is a photon diameter, the photon diameter is not known at present but is ensured to be less than 10⁻¹⁵ meters. Since the photon has no rest mass, the influence of the uncertainty principle on the imaging accuracy of the photon microscope is much smaller, and the accuracy may be higher. The image resolution is increased by several orders of magnitudes compared with the existing electron microscope.

Although the implementation modes of the present invention are explained in combination with the drawings, those ordinary skilled in the art may make various variations or modifications within the scope of the appended claims and may also be a part of the present design.

We claim:

1. A synchronous orthogonal laser image reconstruction super-resolution microscope, wherein
reconstruction of a synchronous orthogonal laser image: synchronous horizontal polarized laser rays and vertical polarized laser rays are alternately used to pass through a sample; when the synchronous horizontal polarized laser rays are magnified by a multilevel lens group to form a magnified real image, the formed image is subjected to spherical aberration correction by a spherical aberration correction component, and a magnified real image 1 is formed on an optical screen, a CCD, a CMOS or a crystal sensitive plate; then the synchronous vertical polarized laser rays pass through the sample and are magnified by the multilevel lens group, the formed image is subjected to the spherical aberration correction by the spherical aberration correction component, and a magnified real image 2 is formed on the optical screen, CCD, CMOS or crystal sensitive plate; the magnified real image 1 and the magnified real image 2 are subjected to the image correlation processing; the greater the correlation is, the greater the grayscale of the image point is; the weaker the correlation is, the smaller the grayscale of the image is; then the real image is filtered and reconstructed into a new super-resolution microscopic image; the horizontal polarized laser rays and the vertical polarized laser rays alternately and circularly pass through the sample, and a dynamic super-resolution image of the sample can be obtained by virtue of the image reconstruction;
reconstruction of synchronous multiple polarized light images: the synchronous polarized laser rays form a transmitted image whenever rotating by an angle (the rotating angle can be set, and a 360/rotating angular-amplitude image can be formed when the polarized light rotates in one circle); the images formed when the polarized light rotates in one circle form a group of (360/rotating angle) polarized light images; one group of polarized light images is subjected to image correlation processing through a computer to form a grayscale image according to the correlation strength; then the grayscale image is filtered and reconstructed into a super-resolution microscopic image; and the polarized light rotates circularly and is processed, thereby obtaining a super-resolution image of a dynamic sample;
spherical aberration correction: the imaging spherical aberration is corrected by the spherical aberration correction component arranged behind the multilevel lenses, so that a clearer image can be formed; or each level of lens magnified images is subjected to the spherical aberration correction by the spherical aberration correction component arranged between the magnification lens group, thereby forming a higher-super-resolution microscopic image;
acquisition of a dynamic rotation polarized light image: a synchronous orthogonal image reconstruction super-resolution microscope light source is generated by a same laser, and a polarized light filter is used for filtering the laser rays to form the polarized light; or the laser light source is filtered by the polarized light filter to form the polarized light; then the polarized light passes through an optical rotation component; the polarized laser is deflected to form rotary polarized laser rays at different time; the rotating polarized laser rays pass through the sample at different time to form the image; the formed image is reconstructed by the computer into a new super-resolution image; or the synchronous orthogonal laser image reconstruction super-resolution microscope light source is generated by the laser, the polarized light filter is used for filtering the polarized light, thereby obtaining the orthogonal polarized laser rays at different time; and the image formed by the polarized laser rays passing through the sample at different time is reconstructed by the computer into the new super-resolution image;
imaging processing of the orthogonal polarized image: the imaging is carried out in a film exposure imaging manner, or the imaging is displayed by the optical screen; or during the imaging, image information is acquired by a CCD image coupling device and transmitted to the computer for processing, storage and display, or an imaging CMOS image sensor acquires the image information and transmits the image information to the computer for processing, storage and display; or the image is induced to emit light through the crystal sensitive plate and then magnified by the optical lenses, thereby forming an image with higher resolution;
image reconstruction of a polarized light image group at any angle: a polarizing plate 2 (105) may adopt a rotary polarizing plate or an electric control liquid crystal polarizing module or an electric control crystal polarizing module or an electric control optical rotation module;
the polarizing plate 2 (105) and the polarizing plate 1 or the polarizing plate 1 in the optical rotation module (102) are controlled to be consistent in polarization direction;
system composition: a laser light source (101), a polarizing plate 1 or an optical rotation component (102), a multilevel lens group (103), a spherical aberration correction component (104), a polarizing plate 2 (105), an optical screen or CCD or CMOS or crystal sensitive plate (106), and a computer (107); the laser light source (101) generates synchronous laser sources;
or the laser light source (101) is provided with two perpendicular light emitting surfaces and a resonant cavity, one group of light-emitting surfaces generates horizontal polarized laser rays; the other group of light emitting surfaces generates vertical polarized laser rays; the two light emitting surfaces are controlled at different time, so that the horizontal polarized laser rays and the vertical polarized laser rays are emitted at different time;
generation of rotary polarized light: a rotary polarizing wafer is used to generate synchronous rotary polarized light, or an electric control liquid crystal polarizing module is used to generate synchronous rotary polarized light, or an electric control crystal polarizing module is used to generate synchronous rotary polarized light, or an electric control optical rotation module is used to generate synchronous rotary polarized light.

2. The synchronous orthogonal laser image reconstruction super-resolution microscope according to claim 1, wherein
system composition:
a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107); the laser light source (101) generates synchronous laser sources;
the laser light source (101) adopts a semiconductor laser, or a gas laser or a solid laser,
or the laser light source (101) is provided with two perpendicular light emitting surfaces and a resonant cavity, one group of light-emitting surfaces generates horizontal polarized laser rays; the other group of light emitting surfaces generates vertical polarized laser rays; the two light emitting surfaces are controlled at different time, so that the horizontal polarized light and the vertical polarized light are transmitted at different time;
the polarizing plate 1 or the optical rotation component (102) adopts a rotary polarizing wafer, or an electric control liquid crystal polarizing module, or an electric control crystal polarizing module or an electric control optical rotation module;
the multilevel optical lens group (103) adopts a lens group to magnify an object image;
the spherical aberration correction component (104) is used to perform the spherical aberration correction for the object image magnified by the lens group; (because the light sources are laser rays, the wavelength and the phase are same, and the color difference correction is not required);
spherical aberration correction: the imaging spherical aberration is corrected by the spherical aberration correction component arranged behind the multilevel lenses, thereby forming a clearer image; or each level of magnified image is subjected to the spherical aberration correction by the spherical aberration correction component arranged between the magnification lens group, thereby forming a higher-super-resolution microscopic image;
the polarizing plate 2 (105) is used to filter the image passing through the multilevel optical lens group (103) and the spherical aberration correction component (104) to remove other reflected light, so that the image is clearer, the polarizing plate 2 (105) adopts a rotary polarizing wafer, or an electric control liquid crystal polarizing module, or an electric control crystal polarizing module or an electric control optical rotation module; or the polarizing plate 2 (105) may not be used;
for the optical screen or CCD or CMOS or liquid crystal sensitive plate (106), the optical screen may be adopted for direct imaging; or the image information obtained by the CCD image coupling device is processed, stored and displayed by the computer or the image information obtained by the CMOS image sensor is processed, stored and displayed by the computer or the crystal sensitive plate emits the light by induction, and the light is magnified by the optical part for imaging;
the image obtained by the CCD image coupling device or the CMOS image sensor is transmitted to the computer (107) for processing, imaging, storage and printing.

3. The synchronous orthogonal laser image reconstruction super-resolution microscope according to claim 1, wherein
generation of rotary polarized light: the rotary polarizing wafer is used to generate synchronous rotary polarized light, or the electric control liquid crystal polarizing module is used to generate the synchronous rotary polarized light, or the electric control crystal polarizing module is used to generate the synchronous rotary polarized light, or the electric control optical rotation module is used to generate the synchronous rotary polarized light;
the polarizing plate 1 or the polarizing plate 1 in the optical rotary part (102): the polarizing plate 1 adopts a polarizing disc which is a polarizing wafer, the center of the polarizing wafer is fixed by a rotating shaft of a motor; the motor drives the polarizing wafer to rotate: a laser light source (202) is fixed on the polarizing wafer outside the center of the polarizing disc; the laser rays are perpendicularly incident on the polarizing wafer, formation of polarized laser rays: a motor (201), a motor rotating shaft (204), a polarizing wafer (203), a laser source (202), a laser ray (205), a laser ray (206), a mark point (207), a luminescent tube (208) and a photoelectric detector (209); polarized laser ray positioning signals: light rays of the luminescent tube (208) and the mark point (207), and the photoelectric detector (209) detects a rotation position status of the polarizing wafer (203) (prior art); the laser ray (205) emitted by the laser source (202) passes through the polarizing wafer (203) and is filtered by the polarizing wafer (203) to form the polarized laser ray (206);
when the horizontal and vertical laser rays (205) at two moments pass through a sample film, and pass through the multilevel optical lens group (103), the spherical aberration correction component (104), the optical screen or the CCD or the CMOS or the crystal sensitive plate (106) to form a magnified real image, the horizontal polarized magnified real image 1 and the vertical polarized magnified real image 2 at two moments are processed by the computer, or the magnified real image 1 and the magnified real image 2 are subjected to the image correlation processing, image reconstruction and image filtering to form a new super-resolution microscopic image.

4. The synchronous orthogonal laser image reconstruction super-resolution microscope according to claim 1, wherein
the polarizing plate 1 or the polarizing plate 1 in the optical rotation component (102): the polarizing plate 1 adopts an electric control liquid crystal polarizing module (302), and a polarization direction of the laser rays passing through the electric control liquid crystal polarizing module is controlled by a level at a control end;
or the polarizing plate 1 or the polarizing plate 1 in the optical rotation component (102): the polarizing plate 1 adopts an electric control crystal polarizing module (402), and the polarization direction of the laser rays passing through the electric control crystal polarizing module is controlled by the level at the control end;
or the polarizing plate 1 or an electric control optical rotation component in the optical rotation component (102): the electric control optical rotation component controls the laser light source (501) as that of the optical rotation module (502), and the polarization direction of the laser rays passing through the electric control optical rotation polarizing module is controlled by the level at the control end;
the polarizing plate 2 (105) may adopt a motor rotation polarizing plate coaxial with the polarizing plate 1, or an electric control liquid crystal polarizing module or an electric control crystal polarizing module or an electric control optical rotation module; and the polarization direction of the polarizing plate 2 (105) is controlled to be consistent with that of the polarizing plate 1 or the polarizing plate 1 in the optical rotation module (102).

5. The synchronous orthogonal laser image reconstruction super-resolution microscope according to claim 1, wherein
the light source is generated by a same laser, and filtered by the polarizing filter to form polarized light; or the laser light source is filtered by the polarizing filter to form polarized light, and then the polarized light passes through the electric control optical rotation module (502) to form orthogonal laser rays at different time; two images formed by the laser rays passing through the sample at different time are reconstructed by the computer into the new super-resolution image;
or the light source adopts the laser to generate laser rays; the laser rays are rotated by the polarizing wafer (203) to form the orthogonal polarized laser rays at different time; and the two images formed by the orthogonal polarized laser rays passing through the sample at different time are reconstructed by the computer into the new super-resolution image;
imaging processing of the orthogonal polarized image: the imaging is carried out in a film exposure imaging manner, or the imaging is displayed by the optical screen; or the image information is acquired by the CCD image coupling device and transmitted to the computer for processing, storage and display, or the image information is acquired by the imaging CMOS image sensor and transmitted to the computer for processing, storage and display; or the image is induced to emit light by the crystal sensitive plate, and then magnified by the optical lenses, thereby forming the image with higher resolution;
the laser rays are transverse waves; the laser rays are coherent light rays having same phase and wavelength; when the two orthogonal beams of polarized laser rays pass through a point on the sample, the polarized laser rays pass through the multilevel optical lens group (103) and the spherical aberration correction component (104) to form the magnified real image; the magnified real image is formed on the optical screen or CCD or CMOS or crystal sensitive plate (106), and the orthogonal waves are strengthened on a same phase point and are counteracted on other points;
according to the present invention, photon fluctuation sites of laser light waves rather than the wave properties are actually used for imaging, thereby forming the clear image, overcoming the restriction of Abbe optics limit, and forming the super-resolution image.

6. The synchronous orthogonal laser image reconstruction super-resolution microscope according to claim 1, wherein
imaging processing of the synchronous polarized image: the synchronous polarized laser rays form a transmitted image whenever rotating by an angle (which may be set arbitrarily), and the images formed by the polarized light rotating in one circle is reconstructed by the computer into the super-resolution microscopic image;
system composition: a laser light source (101), a polarizing plate 1 or an optical rotation component (102), a multilevel optical lens group (103), a spherical aberration correction component (104), a polarizing plate 2 (105), an optical screen or CCD or CMOS or crystal sensitive plate (106), and a computer (107);
or the laser rays emitted by the laser light source (101) pass through the polarizing plate 1 or the optical rotation component (102) to form polarized light which is transmitted onto the sample; the transmitted laser rays pass through the multilevel optical lens group (103) to form the magnified image; the magnified image is corrected by the spherical aberration correction component (104); a polarizing surface of the polarizing plate 2 (105) is same as the polarizing plate 1 or the optical rotation component (102); other light rays are removed by filtering through the polarizing plate 2 (105); the synchronous light forms a polarized light image on the optical screen or CCD or CMOS or crystal sensitive plate (106); and the polarized light image 1 acquired by the CCD or CMOS image sensor in the polarized light image optical screen or CCD or CMOS or crystal sensitive plate (106) is transmitted to the computer (107) for processing, storage and display;
the polarizing plate 1 or the optical rotation component (102) rotates by a settable angle, so that the polarized light of the light rays rotates by an angle, and a polarized light image 2 is formed on the optical screen or CCD or CMOS or crystal sensitive plate (106) and transmitted to the computer (107);
the polarizing plate 1 or the optical rotation component (102) rotates by a settable angle, so that the polarized light of the light rays rotates by an angle, and a polarized light image 3 is formed on the optical screen or CCD or crystal sensitive plate (106) and transmitted to the computer (107);
the polarizing plate 1 or the optical rotation component (102) rotates by n settable angles, so that the polarized light of the light rays rotates by an angle; a polarized light image n is formed on the optical screen or CCD or CID or crystal sensitive plate (106) and transmitted to the computer (107);
the polarizing plate 1 or the optical rotation component (102) rotates by 360 degrees, and n polarized light images are formed and are reconstructed by the computer (107) into a super-high-resolution microscopic image;
the polarized light rays of the polarizing plate 1 or the optical rotation component (102) and the polarized light rays of the polarizing plate 2 (105) are in a synchronous state; or the polarizing plate 2 (105) may not be used, i.e. the polarizing plate 2 (105) is omitted.
